(19) United States
(12) Patent Application Publication
(10) Pub. No.: US 2014/0233443 A1
(43) Pub. Date: Aug. 21, 2014

(54) LINK VERIFICATION IN A WIRELESS NETWORK

(71) Applicant: QUALCOMM INCORPORATED, San Diego, CA (US)

(72) Inventor: Rajeev Kumar, Hyderabad (IN)

(73) Assignee: QUALCOMM INCORPORATED, San Diego, CA (US)

(21) Appl. No.: 13/771,819

(22) Filed: Feb. 20, 2013

(51) Int. Cl. H04W 76/06

(52) U.S. Cl. CPC H04W 76/064
USPC 370/311; 370/328; 370/329

(57) ABSTRACT

A method and apparatus for verifying the status of a wireless connection between a wireless device and an access point are disclosed. If the number of missed beacon frames exceeds a threshold value, the wireless device transmits a link verification request to the access point. If the wireless device receives a response to the link verification request, the wireless device may verify the connection and then retrieve downlink data from the access point. If the wireless device does not receive a response, then the wireless device may terminate the wireless connection.

### TECHNICAL FIELD

The present embodiments relate generally to wireless networks, and specifically to determining the status of a Wi-Fi connection between an access point and a wireless client device.

### BACKGROUND OF RELATED ART

A Wi-Fi network may be formed by one or more access points (APs) that provide a wireless communication channel or link with a number of client devices or stations (STAs). Each AP periodically broadcasts beacon frames to enable any STAs within wireless range of the AP to establish and/or maintain a communication link with the Wi-Fi network. The beacon frames, which may include a traffic indication map (TIM) indicating whether the AP has queued downlink data for the STAs, are typically broadcast according to a target beacon transmission time (TBTT) schedule. Although the IEEE 802.11 standards currently define a TBTT interval of 100 ms, some APs may not comply with these standards.

To reduce power consumption, a STA may enter a “sleep state” (e.g., a low power mode) when not transmitting or receiving data, and then periodically wake-up to listen for beacon frames sent from the AP. The STA may synchronize its wake-up times to substantially coincide with the AP's beacon transmission times so that the STA is awake when the AP broadcasts the beacon frames. If the STA wakes up and does not receive a beacon frame, the STA may return to the sleep state without receiving any downlink data queued by the AP. If the STA misses a predetermined number of consecutive beacon frames, the STA typically assumes that the Wi-Fi network is no longer available and therefore terminates its connection with the AP.

However, if the AP does not broadcast the beacon frames according to its scheduled TBTT intervals, or if an external interference source causes the beacon frames to miss the STA's wake-up times, then the STA may terminate its connection with the Wi-Fi network based upon a mistaken assumption that the Wi-Fi network is no longer available. Thus, there is a need to prevent STAs from terminating valid connections with a Wi-Fi network in response to missing a number of beacon frames from the AP.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A wireless network system and method of operation are disclosed that may prevent STAs from terminating valid connections with an access point (AP) associated with the wireless network. In accordance with the present embodiments, the wireless network system includes a number of APs that may be wirelessly connected to a number of STAs. Each AP may periodically broadcast a beacon frame (e.g., according to its target beacon transmission times (TBTT) schedule). Each STA may wake-up from a sleep state to listen for the beacon frames. If the STA receives the beacon frame, the STA may return to the sleep state. If the STA does not receive an expected beacon frame from its associated AP, the STA may determine that a beacon frame is missing, and in response thereto increment a missed beacon frame count value. The STA may compare the missed beacon frame count value with a threshold value to determine whether a predetermined number of beacon frames expected from the associated AP are missed. If the missed beacon frame count value is less than the threshold value, the STA may return to the sleep state.

Conversely, if the missed beacon frame count value is equal to (or greater than) the threshold value, then the STA may transmit a link verification request to the associated AP. The STA may then listen for a response to the link verification request from the AP. If the STA receives a response from the AP, which may indicate that the connection between the STA and the AP remains valid, then the STA may reset the missed beacon frame count value. If the STA does not receive a response from the AP (e.g., within a predetermined time period), which may indicate that the connection between the STA and the AP is no longer valid, then the STA may terminate the connection with the AP.

### BRIEF DESCRIPTION OF THE DRAWINGS

The present embodiments are illustrated by way of example and are not intended to be limited by the figures of the accompanying drawings, where:

FIGS. 1A and 1B depict a network system within which the present embodiments may be implemented;

FIG. 2 shows a block diagram of a wireless station in accordance with some embodiments;

FIG. 3 shows an illustrative flow chart depicting an exemplary connection status update operation in accordance with some embodiments;

FIG. 4 shows an illustrative flow chart depicting an exemplary power save operation in accordance with some embodiments;

FIG. 5 shows an illustrative flow chart depicting an exemplary link verification operation in accordance with some embodiments; and

FIG. 6 shows an illustrative timing diagram depicting an example operation in accordance with the present embodiments.

### DETAILED DESCRIPTION

The present embodiments are described below in the context of link verification operations performed by Wi-Fi enabled devices for simplicity only. It is to be understood that the present embodiments are equally applicable for performing link verification operations using signals of other various wireless standards or protocols. As used herein, the terms wireless local area network (WLAN) and Wi-Fi can include communications governed by the IEEE 802.11 standards, BLUETOOTH®, HiperLAN (a set of wireless standards, comparable to the IEEE 802.11 standards, used primarily in Europe), and other technologies used in wireless communications. Further, the terms “sleep state” and “power save mode” refer to a low-power operating mode in which one or more components of a Wi-Fi device are deactivated (e.g., to prolong battery life), and thus the terms “sleep state” and “power save mode” may be used interchangeably herein. Further, as used herein, a “missed beacon event” refers to an event in which a STA fails to detect a beacon frame that it was expecting to receive from an associated AP (e.g., during a wake-up time or a “listen state”).

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

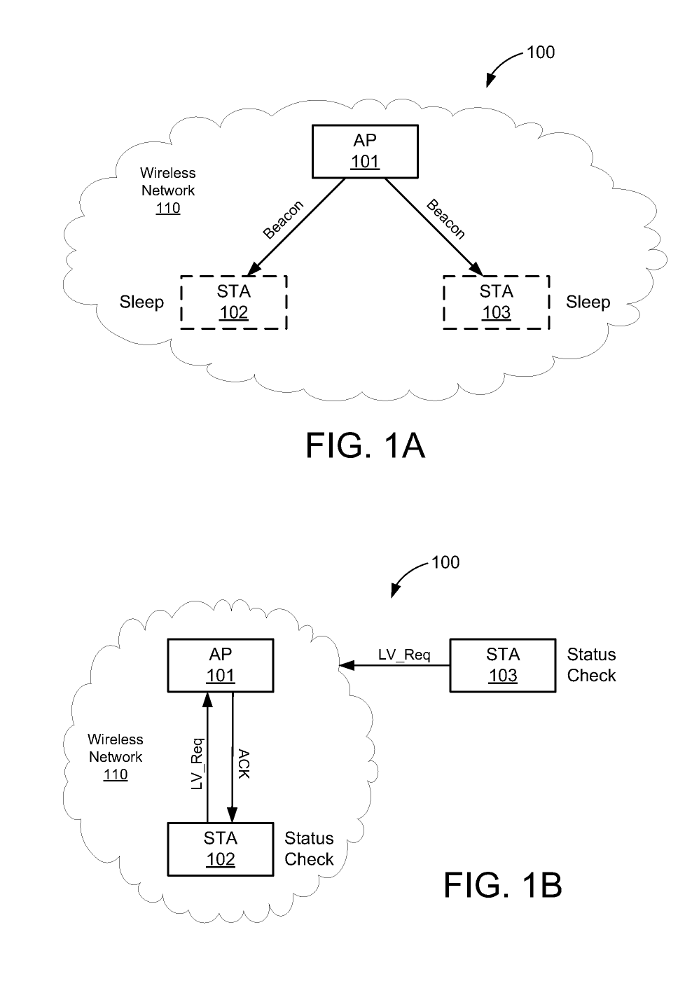

FIGS. 1A-1B depict an example network system 100 within which the present embodiments may be implemented. The system 100 is shown to include an access point (AP) 101 within wireless communication range of wireless stations (STAs) 102 and 103. Although only two STAs 102 and 103 are shown for simplicity, it is to be understood that the system 100 may include any number of STAs. The AP 101 may act as a host and/or gateway for a wireless network 110. Specifically, the AP 101 may periodically broadcast beacon frames to enable the STAs 102 and 103 to establish and/or maintain a connection to the wireless network 110. For example, the beacon frames may advertise operational parameters and/or supported capabilities of the wireless network 110. In addition, each beacon frame may include a traffic indication map (TIM) specifying one or more of the STAs 102 and/or 103 as having downlink data queued in the AP 101.

The STAs 102 and 103 may be any suitable wireless enabled device including, for example, a cell phone, PDA, tablet computer, laptop computer, or the like. Each of the STAs 102 and 103 may operate in an “active state,” a “listen state,” or a “sleep state” while connected to the wireless network 110. While in the active state, the STAs 102 and 103 may be actively exchanging (e.g., transmitting and/or receiving) data with the AP 101. While in the listen state, the STAs 102 and 103 may be passively “listening” to a wireless channel for beacon frames, for incoming data frames, and/or to determine the wireless channel is available for data transmissions from the STA. While in the sleep state, the STAs 102 and 103 are not transmitting, receiving, or listening to the wireless channel; thus, the transmitters and/or receivers of the STA may be powered off or configured to operate in a low-power mode during the sleep state.

After establishing a connection with the wireless network 110, the STAs 102 and 103 may enter the sleep state after being idle (e.g., not transmitting and/or receiving data) for a period of time, thereby reducing power consumption. Because the STAs 102 and 103 may be unable to receive beacon frames while in the sleep state, the STAs 102 and 103 may be configured to periodically “wake up” from the sleep state to listen for beacon frames from the AP 101. More specifically, the STAs 102 and 103 may schedule their wake-up times to substantially coincide with the AP 101's target beacon transmission times to ensure that the STAs 102 and 103 are awake when the AP 101 broadcasts the beacon frames. As mentioned above, the STAs 102 and/or 103 may not receive beacon frames during their wake-up times for a variety of reasons. For example, the AP 101 may not broadcast beacon frames at the scheduled target beacon transmission time (TBTT) intervals. Further, even if the AP 101 broadcasts beacon frames according to the scheduled TBTT intervals, external sources of interference may alter the arrival times of the beacon frames at STA 102 and/or STA 103. As a result, one or more beacon frames broadcast by the AP 101 may arrive either before or after the wake-up times of STA 102 and/or STA 103 (e.g., while the STA 102 and/or STA 103 are in the sleep state), thereby causing STA 102 and/or STA 103 to miss the beacon frames.

For example, as depicted in FIG. 1A, the STAs 102 and 103 are in the sleep state when the AP 101 broadcasts a beacon frame. Although STA 102 and STA 103 may not receive the beacon frames from the AP 101, the STAs 102 and 103 may remain connected to the wireless network 110 (e.g., because the STAs 102 and 103 are still within range of the wireless network 110). For other cases, the STAs 102 and 103 may not receive one or more beacon frames from the AP 101 because the wireless network 110 is no longer available (e.g., the AP 101 is offline) and/or because the STAs 102 and 103 are no longer within range of the wireless network 110.

The STAs 102 and 103 may be configured to actively verify the status of their connections or links to the wireless network 110 after missing a predetermined number of beacon frames. For some embodiments, the STAs 102 and 103 may verify the availability of the wireless network 110 by transmitting a link verification request (LV_Req, shown in FIG. 1B) message to the AP 101 and then detecting whether the AP 101 responds to the LV_Req message. The AP 101 may respond to the LV_Req message, for example, by sending an acknowledgment (ACK) frame to the requesting STA. Referring to FIG. 1B, because STA 102 receives an ACK message from the AP 101 in response to the LV_Req message, the STA 102 may verify its valid connection to the wireless network 110. Conversely, because STA 103 does not receive an ACK message from the AP 101 in response to the LV_Req message, STA 103 may determine that it no longer has a valid connection to the wireless network 110, and thereafter may terminate its connection to the wireless network 110.

In this manner, the STAs 102 and 103 may determine whether to terminate connections to the wireless network 110 based, at least in part, upon whether the AP 101 acknowledges receipt of the LV_Req messages sent from the STAs 102 and 103, respectively. Thus, by actively verifying whether its connections to the wireless network 110 still exist after missing a predetermined number of beacon frames from the AP 101 (e.g., rather than assuming that the connections to the wireless network 110 are no longer valid), STA 102 and STA 103 may avoid prematurely terminating their connections to the wireless network 110. In addition, the LV_Req messages sent to the AP 101 by STA 102 and/or STA 103 may also be used to retrieve downlink data queued in the AP 101, as described in more detail below.

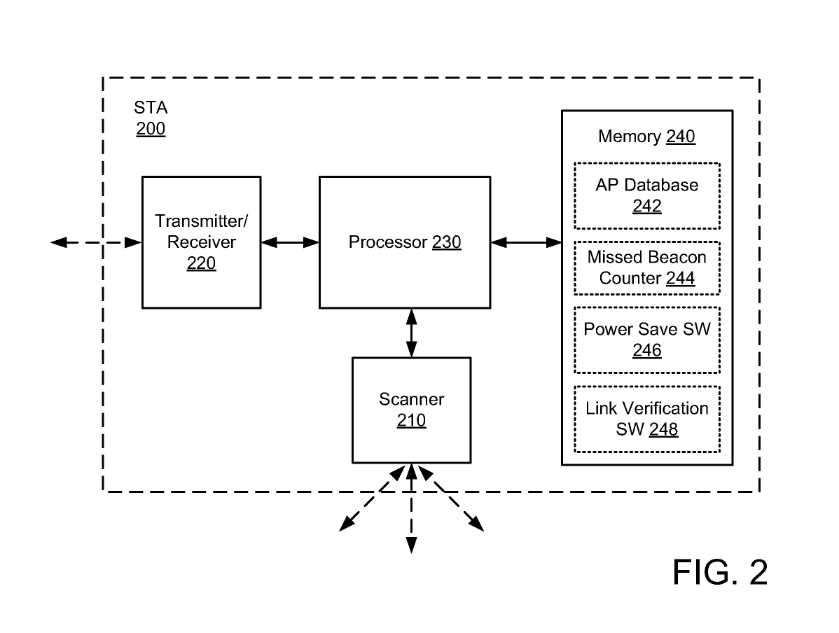

FIG. 2 shows a STA 200 that is one embodiment of the STAs 102 and 103 of FIGS. 1A-1B. The STA 200 includes a scanner 210, a transmitter/receiver circuit 220, a processor 230, and a memory 240. Scanner 210 may be used to scan the surrounding environment to detect and identify nearby APs and/or peer STAs (e.g., when operating in a peer-to-peer (P2P) mode). For some embodiments, the scanner 210 may search for APs by listening for beacon frames broadcast by APs within wireless communications range. The transmitter/receiver (or “transceiver”) circuit 220 may then be used to transmit signals to and receive signals from the discovered APs.

Memory 240 may include an AP database 242 that can be used as a local cache to store the media access control (MAC) addresses or other identifying information of a plurality of APs, the location coordinates of such APs, beacon transmission times, supported data rates, and/or other suitable location or configuration information pertaining to the APs. For some embodiments, each entry of the AP database 242 may include an access point field to store the name of the associated AP, a basic service set identification (BSSID) field to store the MAC address of the AP, a beacon interval field to store the time duration between successive beacon frame transmissions, and/or a data rate field to store one or more supported data transmission rates of the AP. Memory 240 may also include a missed beacon counter 244 that stores a missed beacon count value (B_{M}) indicating a number of consecutively missed beacon frames from the associated AP.

Further, memory 240 may also include a non-transitory computer-readable storage medium (e.g., one or more nonvolatile memory elements, such as EPROM, EEPROM, Flash memory, a hard drive, etc.) that can store the following software modules:
a power save (PS) software module 246 to enter the STA 200 into the sleep state, to periodically wake up the STA 200 from the sleep state (e.g., to listen for beacon frames from an associated AP), and/or to detect a number of missed beacon frames; and
a link verification (LV) software module 248 to initiate a link verification operation to check the status of the connection between the STA 200 and the associated AP, to maintain the connection with the associated AP (e.g., despite missing a number of beacon frames from the associated AP), and/or to terminate the connection with the associated AP.

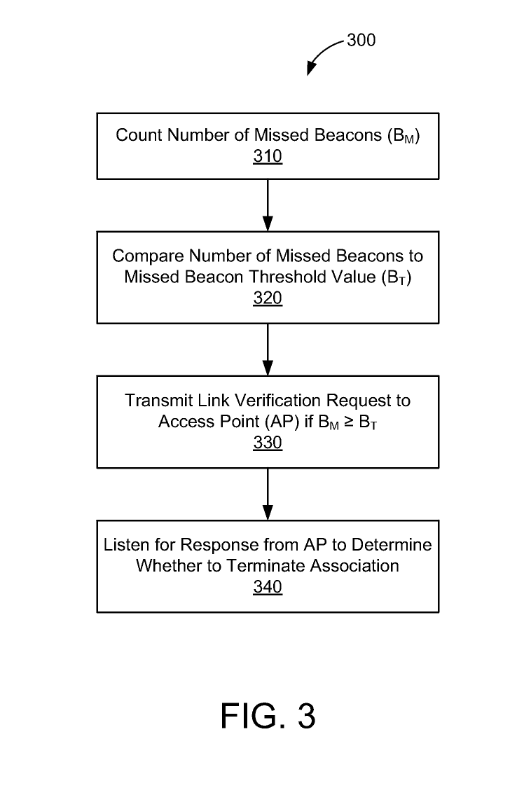

Each software module includes program instructions that, when executed by processor 230, may cause the STA 200 to perform the corresponding function. Thus, the non-transitory computer-readable storage medium of memory 240 may include instructions for performing all or a portion of the operations described below with respect to FIGS. 3-5.

Processor 230, which is coupled to scanner 210, transceiver 220, and memory 240, may be any suitable processor capable of executing scripts or instructions of one or more software programs stored in the STA 200 (e.g., within memory 240). For example, processor 230 may execute the PS software module 246 and/or the LV software module 248. The PS software module 246 may be executed by the processor 230 to enter the STA 200 into the sleep state, to periodically wake up the STA 200 from the sleep state (e.g., to listen for beacon frames and/or retrieve downlink data from the associated AP), and/or to detect a number of missed beacon frames.

More specifically, for some embodiments, processor 230 may execute the PS software module 246 to wake up the STA 200 from the sleep state when a beacon frame is expected to be transmitted by an associated AP, and place the STA 200 in the listen state for the wake-up time period. Each wake-up time period may be scheduled to substantially coincide with the associated AP's TBTT intervals (e.g., as stored in the AP database 242). The PS software module 246 may update the missed beacon count value B_{M} at the end of each wake-up time period. For example, if the STA 200 does not receive the beacon frame during the wake-up time period, then PS software module 246 may increment the value of B_{M}. Conversely, if the STA 200 receives the beacon frame during the wake-up time period, then PS software module 246 may reset the value of B_{M} (e.g., to zero).

For some embodiments, the PS software module 246 may compare the missed beacon count value B_{M} with a missed beacon threshold value (B_{T}) after each wake-up time period. The threshold value B_{T} may correspond to a predetermined number of beacon frames that the STA 200 is to miss before actively verifying the availability and/or validity of the connection to the wireless network 110. Thereafter, if the number of missed beacon frames is less than the threshold value (e.g., if B_{M}<B_{T}), then the PS software module 246 may maintain the connection to the wireless network 110 and cause the STA 200 to enter the sleep state. Conversely, if the number of missed beacon frames is greater than or equal to the threshold value (e.g., if B_{M}≧B_{T}), then the PS software module 246 may initiate the link verification operation to actively verify the availability and/or validity of the connection to the wireless network 110 (e.g., by causing processor 230 to execute the LV software module 248).

Processor 230 may execute the LV software module 248 to actively verify the status of the connection between the STA 200 and the associated AP. More specifically, the LV software module 248 may generate the LV_Req message to be transmitted from the STA 200 to the AP 101 (via the transceiver 220), and then listen for a response (e.g., an acknowledgement (ACK) frame) from the AP 101. For some embodiments, the LV_Req message may be a PS poll request message. For other embodiments the LV_Req message may be a NULL data frame. Thereafter, the processor 230 may either maintain the connection with the associated AP or terminate the connection with the associated AP depending upon whether the associated AP acknowledges receipt of the LV_Req message. For example, if the STA 200 receives a response from the associated AP (e.g., an ACK frame), then the processor 230 may maintain the connection with the associated AP. Conversely, if STA 200 does not receive a response from the associated AP (e.g., the associated AP is offline and/or no longer within wireless range of the STA 200), then processor 230 may terminate the connection with the associated AP.

For some embodiments, the LV software module 248 may be used to retrieve downlink data queued in the associated AP. For example, after missing one or more beacon frames, the STA 200 may not know whether it has downlink data waiting in the associated AP's queue (e.g., because the STA 200 did not receive the TIM bits contained in the beacon frames). Thus, for at least some embodiments, the LV_Req message sent from the STA 200 may instruct the associated AP to send any downlink data (if available) to the STA 200. For one example, if the associated AP is configured to automatically send downlink data to the STA 200 in response to a PS poll request, then the LV software module 248 may send a PS poll request as the LV_Req message to the associated AP. For another example STA 200, if the associated AP is not configured to respond to PS poll requests, then the LV software module 248 may send a NULL data frame (e.g., having its power management bit set to zero) as the LV_Req message, which in turn may instruct the associated AP to send any available downlink data to the STA 200.

FIG. 3 is an illustrative flow chart depicting an exemplary connection status update operation 300 in accordance with some embodiments. As described above, the present embodiments may prevent STA 200 from prematurely terminating its connection with an associated AP and/or wireless network. It is to be understood that although the connection status update operation 300 is described below with respect to STA 200, the connection status update operation 300 may be implemented by any STA in accordance with the present embodiments (e.g., by STA 102 and STA 103 shown in FIGS. 1A-1B). The STA 200 performs the status update operation 300 by first counting the number of missed beacon frames (e.g., as indicated by the missed beacon count value B_{M}) (310). As mentioned above, the STA 200 may periodically wake up from the sleep state to listen for a beacon frame expected to be broadcast from the associated AP, and then increment the value of B_{M} if the STA 200 does not receive the beacon frame during the wake-up time period.

The STA 200 compares the missed beacon count value B_{M} with the predetermined missed beacon threshold value (B_{T}) (320). For at least one embodiment, the STA 200 may compare the number of missed beacon frames B_{M} with the missed beacon threshold value B_{T} each time the value of B_{M} is incremented. For at least another embodiment, the STA 200 may compare the number of missed beacon frames B_{M} with the missed beacon threshold value B_{T} each time the STA 200 returns to the sleep state.

If the number of missed beacon frames is greater than or equal to the threshold value, B_{M}≧B_{T}), (or in another embodiment B_{M}>B_{T}), then the STA 200 may actively verify the validity of its connection with the associated AP by transmitting a LV_Req message to the associated AP (330). As described above, the LV_Req message may be a PS poll request, a NULL data frame, and/or any other suitable frame, packet, or message that elicits a response from the associated AP.

Next, the STA 200 listens for a response from the associated AP to determine whether to maintain the connection with the associated AP or to terminate the connection with the associated AP (340). For some embodiments, the STA 200 may maintain the connection with the associated AP if the STA 200 receives a response (e.g., an ACK frame) from the associated AP, and may terminate the connection with the associated AP if the STA 200 does not receive a response (e.g., an ACK frame) from the associated AP (e.g., within a predetermined time period after transmitting the LV_Req message). For some embodiments, the STA 200 may retrieve any available downlink data from the associated AP upon verifying that the connection with the associated AP is still valid.

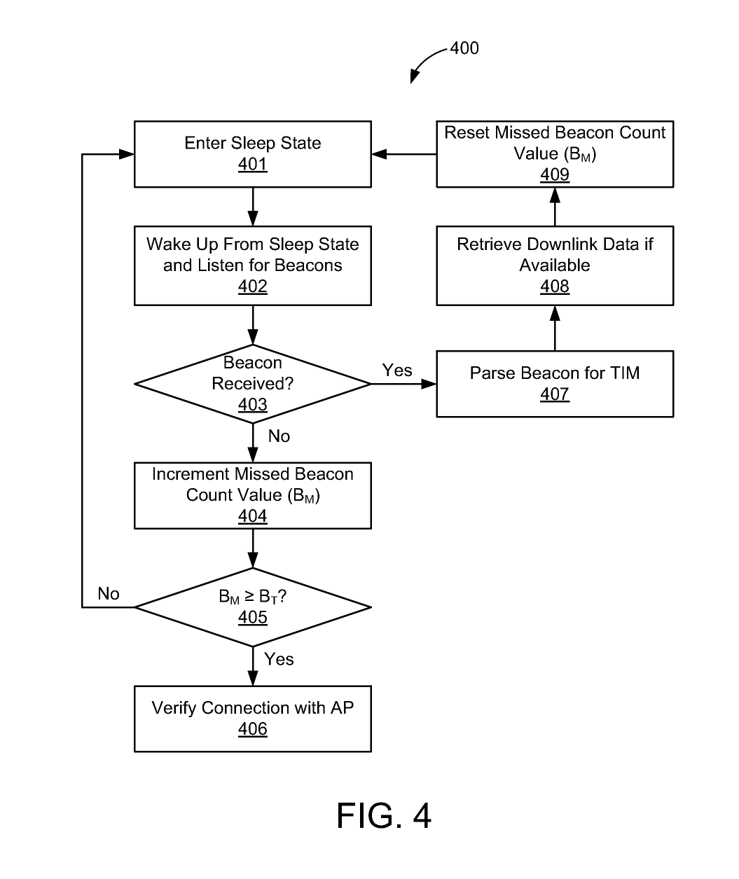

FIG. 4 is an illustrative flow chart depicting an exemplary power save operation 400 in accordance with some embodiments. Although the power save operation 400 is described below with respect to STA 200, the power save operation 400 may be implemented by any STA in accordance with the present embodiments (e.g., by STA 102 and STA 103 shown in FIGS. 1A-1B). The STA 200 may initiate the power save operation 400 by first entering into the sleep state (401). For some embodiments, the STA 200 may enter the sleep state after remaining idle for a predetermined time period. When the STA 200 expects the associated AP to transmit a beacon frame, the STA 200 wakes up from the sleep state and enters the listen state to listen for incoming beacon frames (402). For some embodiments, the STA 200 may schedule its wake-up times to substantially coincide with the target beacon transmission times of the associated AP. For at least one embodiment, the STA 200 may wake up from the sleep state prior to an expected beacon arrival time and/or remain in the listen state until after the expected beacon arrival time, thereby allowing additional time (a tolerance) to receive the beacon frame from the associated AP.

During the wake-up time period or after the wake-up time period expires, the STA 200 may determine whether a beacon frame was received from the associated AP (403). If the STA 200 receives the beacon frame at 402 (as tested at 403), then the STA 200 may parse the beacon frame for TIM data to determine whether the associated AP has queued downlink data for the STA 200 (407). If the TIM of the received beacon frame indicates that there is downlink data available for the STA, then the STA 200 may retrieve the downlink data from the associated AP (408). For at least one embodiment, the STA 200 may transmit a PS poll request to the associated AP instructing the AP to send the queued downlink data to the STA. For at least another embodiment, the STA 200 may transmit a NULL frame (having its power management bit set to zero) to the associated AP instructing the AP to send the queued downlink data to the STA. Next, the STA 200 may reset the missed beacon count value B_{M} (e.g., to zero) (409), and then return to the sleep state (401).

Conversely, if the STA 200 did not receive a beacon from the associated AP at 402 (as tested at 403), then the STA 200 may increase the value of B_{M} (e.g., increment by one) to indicate a missed beacon event (404). As mentioned above, the missed beacon event may result from, e.g., the beacon frame arriving either before or after the STA's wake-up time period, from a failure of the associated AP to broadcast the beacon frame, and/or from the STA 200 moving out of wireless range of the associated AP.

Next, the STA 200 may compare the value of B_{M} with the threshold value B_{T} (405). If the number of missed beacon frames is less than the threshold value (e.g., if B_{M}<B_{T}), as tested at 405, then the STA 200 may return to the sleep state (401). Conversely, if the number of missed beacon frames is greater than or equal to the threshold value (e.g., if B_{M}≧B_{T}), as tested at 405, then the STA 200 may actively verify the status of its connection with the associated AP (406).

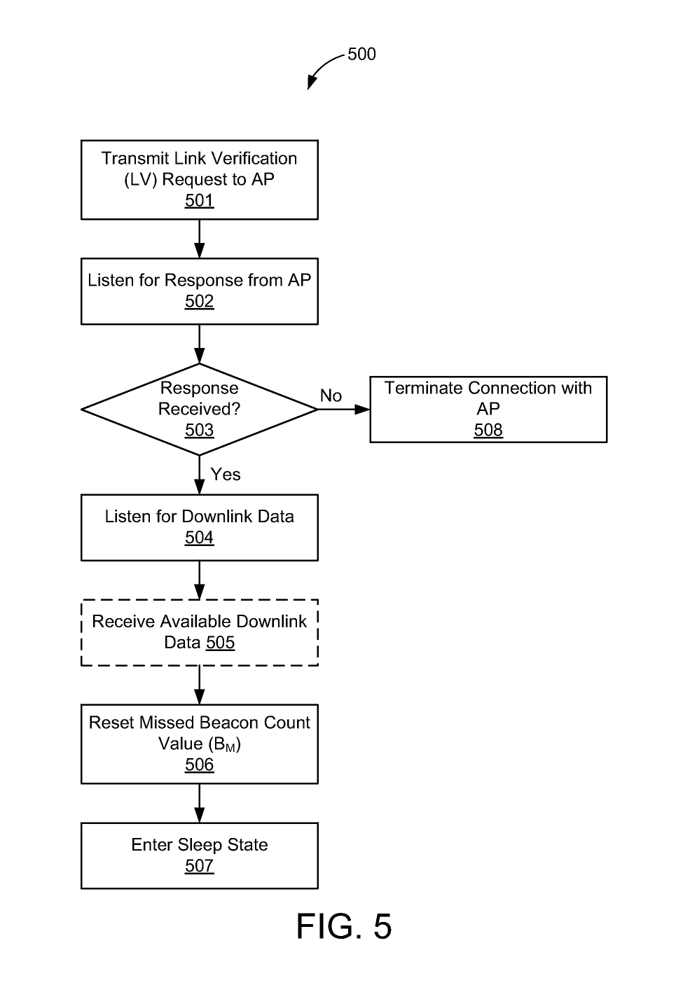

FIG. 5 is a flow chart depicting an exemplary link verification operation 500 in accordance with some embodiments. Although the link verification operation 500 is described below with respect to STA 200, the link verification operation 500 may be implemented by any STA configured in accordance with the present embodiments (e.g., by STA 102 and STA 103 shown in FIGS. 1A-1B). The STA 200 may initiate the link verification operation 500 by transmitting a LV_Req message to the associated AP (501). For some embodiments, the LV_Req message may be a PS poll request, while for other embodiments the LV_Req message may be a NULL data frame. Then, the STA 200 listens for a response (e.g., an ACK frame) from the associated AP (502). If the STA 200 does not receive a response from the associated AP within a predetermined time period, as tested at 503, then the STA 200 may terminate its connection with the associated AP (508). For example, if the STA 200 does not receive a response from the associated AP, then the STA 200 may no longer be able to communicate with the AP, and therefore the STA 200 may terminate the connection (e.g., to save power and/or to connect with another AP).

Conversely, if the STA 200 receives a response from the associated AP, as tested at 503, then the STA 200 may listen for downlink data queued in the AP (504). As mentioned above, the STA 200 may send a PS poll request (or a NULL frame having its power management bit set to zero) as the LV_Req message to (i) elicit a response from the AP and (ii) to instruct the AP to send any available downlink data to the STA. Thus, if the associated AP has downlink data available for the STA, then the STA 200 may receive the downlink data from the AP in response to the PS poll request (or NULL frame) (505).

Next, the STA 200 resets the value of B_{M} (e.g., to zero) (506). Although the STA 200 did not receive a beacon frame from the associated AP, the value of B_{M} may be reset because the STA 200 has successfully verified that its connection with the AP remains valid (e.g., by eliciting a response from the AP and/or receiving downlink data from the AP). Thereafter, the STA 200 may enter the sleep state to reduce power consumption (507).

It should be noted that the LV_Req messages are not limited to PS poll requests and/or NULL data frames, as described in the foregoing embodiments. Rather, for some embodiments, the LV_Req message may be any data frame, management frame, or control frame that elicits a response from the associated AP.

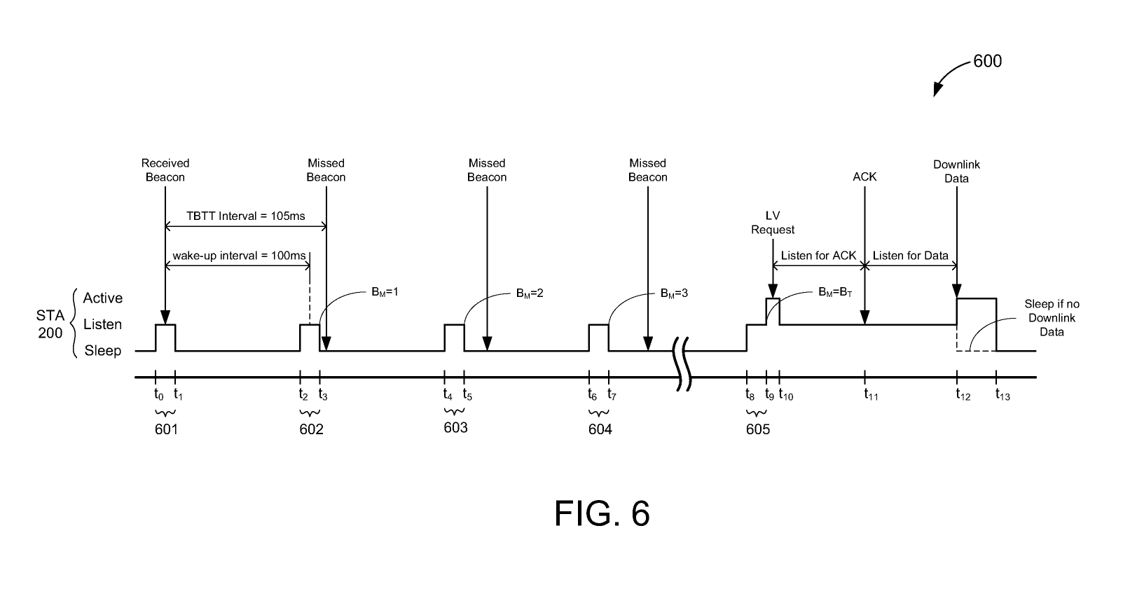

FIG. 6 is a timing diagram depicting an example operation 600 in accordance with some embodiments. Although the operation 600 is described below with respect to STA 200, the operation 600 may be implemented by any STA in accordance with the present embodiments (e.g., by STA 102 and STA 103 shown in FIGS. 1A-1B). Note that FIG. 6 depicts the AP's TBTT interval as 105ms and depicts the STA's wake-up time interval as 100ms, and therefore the AP's TBTT interval is greater than the STA's wake-up time interval. For the example operation 600 depicted in FIG. 6, the STA 200 has a missed beacon threshold value B_{T}=4.

At time t₀, the STA 200 wakes up from the sleep state and receives a beacon frame from the associated AP during the first wake-up time period 601 (e.g., between times t₀ and t₁). Thereafter, the STA 200 returns to the sleep state.

At time t₂, the STA 200 wakes up from the sleep state but does not receive a beacon frame from the AP during the second wake-up time period 602 (e.g., between times t₂ and t₃) because the AP broadcasts the beacon frame after the STA's second wake-up time period 602 expires at time t₃. In response to the missed beacon event, the STA 200 increments the missed beacon count value to B_{M}=1 and re-enters the sleep state. Note that because the AP's TBTT interval is greater than the STA's wake-up time interval, the STA's wake-up time periods grow increasingly out of synchronization with the AP's beacon frame broadcasts.

At time t₄, the STA 200 wakes up from the sleep state but does not receive a beacon frame from the AP during the third wake-up time period 603 (e.g., between times t₄ and t₅) because the AP broadcasts the beacon frame after the STA's third wake-up time period 603 expires at time t₅. In response to the missed beacon event, the STA 200 increments the missed beacon count value to B_{M}=2 and re-enters the sleep state.

At time t₆, the STA 200 wakes up from the sleep state but does not receive a beacon frame from the AP during the fourth wake-up time period 604 (e.g., between times t₆ and t₇) because the AP broadcasts the beacon frame after the STA's fourth wake-up time period 604 expires at time t₇. In response to the missed beacon event, the STA 200 increments the missed beacon count value to B_{M}=3 and re-enters the sleep state.

At time t₈, the STA 200 wakes up from the sleep state but does not receive a beacon frame from the AP during the fifth wake-up time period 605 (e.g., between times t₈ and t₉) because the AP broadcasts the beacon frame after the STA's fifth wake-up time period 605 expires at time t₉. In response to the missed beacon event, the STA 200 increments the missed beacon count value to B_{M}=4.

Because the value of B_{M} now equals the threshold value B_{T} (i.e., B_{M}=B_{T}=4), the STA 200 actively verifies the validity of the connection with the AP by transmitting a LV_Req message to the AP between times t₉-t₁₀. Then, between times t₁₀-t₁₁, the STA 200 listens for a response (e.g., an ACK frame) sent from the AP in response to the LV_Req message. The STA 200 receives the response from the AP at time t₁₁, and in response thereto verifies the validity of the connection with the AP.

For the example operation depicted in FIG. 6, the STA 200 continues listening to the wireless channel for downlink data sent from the AP (between times t₁₁-t₁₂) As mentioned above, for some embodiments, transmission of the LV_Req to the AP may cause the AP to send any available downlink data to the STA. Thus, as depicted in FIG. 6, at time t₁₂ the STA 200 receives downlink data from the AP, and returns to the sleep state at time t₁₃. Note that if the STA 200 does not receive any downlink data from the AP after listening to the wireless channel for a predetermined time period (e.g., between times t₁₁-t₁₂), then the STA 200 may return to the sleep state at time t₁₂.

Note that if the STA 200 did not receive a response from the AP by time t₁₁, the STA 200 may terminate its connection with the AP rather than continue listening to the wireless channel (e.g., which may indicate that the connection with the AP is no longer valid).

By enabling the STA 200 to actively verify the status of the wireless connection with the AP after missing a predetermined number of beacon frames, the present embodiments may ensure that the STA 200 does not prematurely terminate its connection with the AP. This may ensure that valid connections with the AP are not terminated because the AP did not adhere to its scheduled TBTT intervals or because reception of the beacon frames was otherwise delayed (e.g., due to external sources of interference). In contrast, conventional STAs may terminate valid connections with the AP without actively verifying the connection status with the AP. Further, by sending a PS poll message, a NULL data frame, or other suitable frame as the LV_Req message to verify the status of the connection with the AP, at least some of the present embodiments may be implemented entirely within the STA.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense. For example, the method steps depicted in the flow charts of FIGS. 3-5 may be performed in other suitable orders and/or multiple steps may be combined into a single step.

What is claimed is:

1. A method of operating a wireless device associated with an access point in a wireless network, the method comprising:
counting a number of missed beacon frames corresponding to the access point;
comparing the number of missed beacon frames with a threshold value;
transmitting a link verification request to the access point if the number of missed beacon frames equals the threshold value;
listening for a response, from the access point, to the link verification request; and
selectively terminating a connection with the access point in response to the listening.

2. The method of claim 1, wherein counting the number of missed beacon frames comprises:
periodically waking up from a sleep state to listen for an expected beacon frame during a wake-up time period; and
incrementing the number of missed beacon frames if the wireless device does not receive the expected beacon frame from the access point during the wake-up time period.

3. The method of claim 2, wherein the periodically waking up comprises:
scheduling the wake-up time period to substantially coincide with a target beacon transmission time corresponding to the access point.

4. The method of claim 1, wherein the selectively terminating comprises:
terminating the connection with the access point if the wireless device does not receive the response from the access point; and
verifying the connection with the access point if the wireless device receives the response from the access point.

5. The method of claim 4, further comprising:
resetting the number of missed beacon frames to zero if the connection is verified.

6. The method of claim 4, further comprising:
retrieving downlink data from the access point if the connection is verified.

7. The method of claim 6, wherein the link verification request triggers retrieving the downlink data.

8. The method of claim 1, wherein the link verification request comprises a power save poll request.

9. The method of claim 1, wherein the link verification request comprises a null frame including a power management bit set to zero.

10. A computer-readable storage medium containing program instructions that, when executed by a processor of a wireless device associated with an access point in a wireless network, causes the wireless device to:
count a number of missed beacon frames corresponding to the access point;
compare the number of missed beacon frames with a threshold value;
transmit a link verification request to the access point if the number of missed beacon frames equals the threshold value;
listen for a response, from the access point, to the link verification request; and
selectively terminate a connection with the access point in response to the listening.

11. The computer-readable storage medium of claim 10, wherein execution of the program instructions to count the number of missed beacon frames causes the wireless device to:
periodically wake up from a sleep state to listen for an expected beacon frame during a wake-up time period; and
increment the number of missed beacon frames if the wireless device does not receive the expected beacon frame from the access point during the wake-up time period.

12. The computer-readable storage medium of claim 11, wherein execution of the program instructions to periodically wake up causes the wireless device to:
schedule the wake-up time period to substantially coincide with a target beacon transmission time corresponding to the access point.

13. The computer-readable storage medium of claim 10, wherein execution of the program instructions to selectively terminate causes the wireless device to:
terminate the connection with the access point if the wireless device does not receive the response from the access point; and
verify the connection with the access point if the wireless device receives the response from the access point.

14. The computer-readable storage medium of claim 13, wherein execution of the program instructions further causes the wireless device to:
reset the number of missed beacon frames to zero if the connection is verified.

15. The computer-readable storage medium of claim 13, wherein execution of the program instructions further causes the wireless device to:
retrieve downlink data from the access point if the connection is verified.

16. The computer-readable storage medium of claim 15, wherein the link verification request triggers retrieving the downlink data.

17. The computer-readable storage medium of claim 10, wherein the link verification request comprises a power save poll request.

18. The computer-readable storage medium of claim 10, wherein the link verification request comprises a null frame including a power management bit set to zero.

19. A wireless device, comprising:
a receiver to receive beacon frames broadcast by an access point;
a transmitter to transmit a link verification request to the access point; and
a processor to:
count a number of missed beacon frames corresponding to the access point;
compare the number of missed beacon frames with a threshold value;
transmit the link verification request to the access point if the number of missed beacon frames equals the threshold value;
listen for a response, from the access point, to the link verification request; and
selectively terminate a connection with the access point in response to the listening.

20. The wireless device of claim 19, wherein the processor is to count the number of missed beacon frames by:
periodically waking up from a sleep state to listen for an expected beacon frame during a wake-up time period; and
incrementing the number of missed beacon frames if the wireless device does not receive the expected beacon frame from the access point during the wake-up time period.

21. The wireless device of claim 20, wherein the processor is to periodically wake up by:
scheduling the wake-up time period to substantially coincide with a target beacon transmission time corresponding to the access point.

22. The wireless device of claim 19, wherein the processor is to selectively terminate by:
terminating the connection with the access point if the wireless device does not receive the response from the access point; and
verifying the connection with the access point if the wireless device receives the response from the access point.

23. The wireless device of claim 22, wherein the processor is to further:
reset the number of missed beacon frames to zero if the connection is verified.

24. The wireless device of claim 22, wherein the processor is to further:
retrieve downlink data from the access point if the connection is verified.

25. The wireless device of claim 24, wherein the link verification request triggers retrieving the downlink data.

26. The wireless device of claim 19, wherein the link verification request comprises a power save poll request.

27. The wireless device of claim 19, wherein the link verification request comprises a null frame including a power management bit set to zero.

28. A wireless device, comprising:
means for counting a number of missed beacon frames corresponding to an access point;
means for comparing the number of missed beacon frames with a threshold value;
means for transmitting a link verification request to the access point if the number of missed beacon frames equals the threshold value;
means for terminating a connection with the access point if the wireless device does not receive a response to the link verification request from the access point; and
means for verifying the connection with the access point if the wireless device receives the response to the link verification request from the access point.

29. The wireless device of claim 28, wherein the wireless device is to:
periodically wake up from a sleep state to listen for an expected beacon frame during a wake-up time period; and
increment the number of missed beacon frames if the wireless device does not receive the expected beacon frame from the access point during the wake-up time period.

30. The wireless device of claim 28, further comprising:
means for retrieving downlink data from the access point if the connection is verified.

31. The wireless device of claim 30, wherein the link verification request triggers a retrieval of the downlink data.
